(19) United States
(12) Patent Application Publication
(10) Pub. No.: US 2024/0077922 A1
(43) Pub. Date: Mar. 7, 2024

(54) ELECTRONIC SYSTEM USING USB TYPE-C PORT AND ABNORMAL ELIMINATION METHOD THEREOF

(71) Applicant: Acer Incorporated, New Taipei City (TW)

(72) Inventors: Yuan-Yi Li, New Taipei City (TW); Ming-Feng Hsieh, New Taipei City (TW); Chun-Chih Kuo, New Taipei City (TW)

(73) Assignee: Acer Incorporated, New Taipei City (TW)

(21) Appl. No.: 18/072,612

(22) Filed: Nov. 30, 2022

(30) Foreign Application Priority Data
Sep. 1, 2022 (TW) 111133249

(51) Int. Cl. G06F 1/26; G06F 1/24; G06F 1/28; G06F 13/42

(52) U.S. Cl. CPC G06F 1/266; G06F 1/24; G06F 1/28; G06F 13/4282; G06F 2213/0042

(57) ABSTRACT

An electronic system using a USB type-C port and an abnormal elimination method thereof are provided. After sending a hard reset request to a power adapter, a host device determines whether to enter an error recovery state according to whether an initialization signal is at a first preset level for a first preset time, so that the initialization signal is changed to a second preset level, or whether to force the initialization signal to change to the second preset level according to whether the initialization signal is at the first preset level for a second preset time.

### CROSS-REFERENCE TO RELATED APPLICATION

This application claims the priority benefit of Taiwan application serial no. 111133249, filed on Sep. 1, 2022. The entirety of the above-mentioned patent application is hereby incorporated by reference herein and made a part of this specification.

### BACKGROUND

### Technical Field

The disclosure is about an electronic device, and in particular, relates to an electronic system using a USB type-C port and an abnormal elimination method thereof.

### Description of Related Art

Portable electronic devices have become an integral part of modern life. These electronic devices can be connected to each other through a communication interface for expansion. A common communication interface nowadays is the Universal Serial Bus (USB). In the current USB protocol, the USB type-C port supports dual-role port (DRP) and super high-speed data transmission and is used as a wide-range power input/output port. Therefore, it has become a commonly used communication interface.

Generally speaking, when an electronic device and an expansion device are powered through the USB type-C interface, a set of configuration channel (CC) pins (e.g., CC1 pin and CC2 pin) are required to communicate between the two devices for a power delivery (PD) protocol to determine the power role of the two devices as the power source or power sink.

However, since the PD protocol of the USB type-C port is not very strict, the charging architecture based on the PD protocol of the USB type-C port sometimes causes the system to appear abnormal, for example, preventing the system from shutting down. Therefore, how to effectively prevent the system from malfunctioning due to the PD protocol of the USB type-C port is a very important issue.

### SUMMARY

The disclosure provides an electronic system using a USB type-C port and an abnormal elimination method thereof, which may effectively avoid the problem of system abnormality caused by the PD protocol of the USB type-C port.

The electronic system using a USB type-C port of the disclosure includes a host device and a power adapter. The host device includes a USB type-C port. The power adapter is configured to connect an alternating current to the USB type-C port and convert the alternating current into a system voltage and supply power to the host device. After sending a hard reset request to a power adapter, a host device determines whether to enter an error recovery state according to whether an initialization signal is at a first preset level for a first preset time, so that the initialization signal is changed to a second preset level, or whether to force the initialization signal to change to the second preset level according to whether the initialization signal is at the first preset level for a second preset time. The initialization signal indicates to the host device whether to execute shutdown.

In an embodiment of the disclosure, the host device also determines whether to force the initialization signal to change to the second preset level according to whether a voltage of a power transmission cable of the power adapter is lower than a preset voltage.

In an embodiment of the disclosure, the host device forces the initialization signal to change to the second preset level in response to the initialization signal being at the first preset level for the second preset time and the voltage of the power transmission cable being lower than the preset voltage.

In an embodiment of the disclosure, the preset voltage is 0V.

In an embodiment of the disclosure, the host device enters the error recovery state in response to the initialization signal being at the first preset level for the first preset time.

In an embodiment of the disclosure, the second preset time is longer than the first preset time.

In an embodiment of the disclosure, the host device executes shutdown in response to the initialization signal being at the second preset level.

In an embodiment of the disclosure, the USB type-C port supports a dual-role port (DRP) function.

In an embodiment of the disclosure, the power adapter connects to the alternating current via a socket.

In an embodiment of the disclosure, the second preset level is higher than the first preset level.

The disclosure further provides an abnormal elimination method of an electronic system. The electronic system includes a host device with a USB type-C port and a power adapter configured to connect an alternating current to the USB type-C port. The abnormal elimination method of the electronic system using the USB type-C port includes: using the power adapter to convert the alternating current into a system voltage and supply power to the host device; and determining whether to enter an error recovery state according to whether an initialization signal is at a first preset level for a first preset time after sending a hard reset request to the power adapter, so that the initialization signal is changed to a second preset level, or whether to force the initialization signal to change to the second preset level according to whether the initialization signal is at the first preset level for a second preset time. The initialization signal indicates to the host device whether to execute shutdown.

In an embodiment of the disclosure, the abnormal elimination method of the electronic system further includes determining whether to force the initialization signal to change to the second preset level according to whether a voltage of a power transmission cable of the power adapter is lower than a preset voltage.

In an embodiment of the disclosure, in response to the initialization signal being at the first preset level for the second preset time and the voltage of the power transmission cable being lower than the preset voltage, the initialization signal is forced to change to the second preset level.

In an embodiment of the disclosure, the preset voltage is 0V.

In an embodiment of the disclosure, in response to the initialization signal being at the first preset level for the first preset time, the host device is controlled to enter the error recovery state.

In an embodiment of the disclosure, the second preset time is longer than the first preset time.

In an embodiment of the disclosure, the host device executes shutdown in response to the initialization signal being at the second preset level.

In an embodiment of the disclosure, the USB type-C port supports a dual-role port (DRP) function.

In an embodiment of the disclosure, the power adapter connects to the alternating current via a socket.

In an embodiment of the disclosure, the second preset level is higher than the first preset level.

Based on the above, after sending a hard reset request to a power adapter, a host device of an embodiment of the disclosure determines whether to enter an error recovery state according to whether an initialization signal is at a first preset level for a first preset time, so that the initialization signal is changed to a second preset level, or whether to force the initialization signal to change to the second preset level according to whether the initialization signal is at the first preset level for a second preset time. In this way, the initialization signal may be prevented from staying at the first preset level, so that the host device may return to a normal shutdown state, which may effectively prevent the system from malfunctioning due to the PD protocol of the USB type-C port.

### BRIEF DESCRIPTION OF THE DRAWINGS

FIG. 1 is a schematic view of an electronic system using a USB type-C port according to an embodiment of the disclosure.

FIG. 2 is a schematic view of a PD state machine of a USB type-C port according to an embodiment of the disclosure.

FIG. 3 is an oscillogram of a power signal and an initialization signal of a conventional power transmission cable.

FIG. 4 is a flow chart of an abnormal elimination method of an electronic system using a USB type-C port according to an embodiment of the disclosure.

### DESCRIPTION OF THE EMBODIMENTS

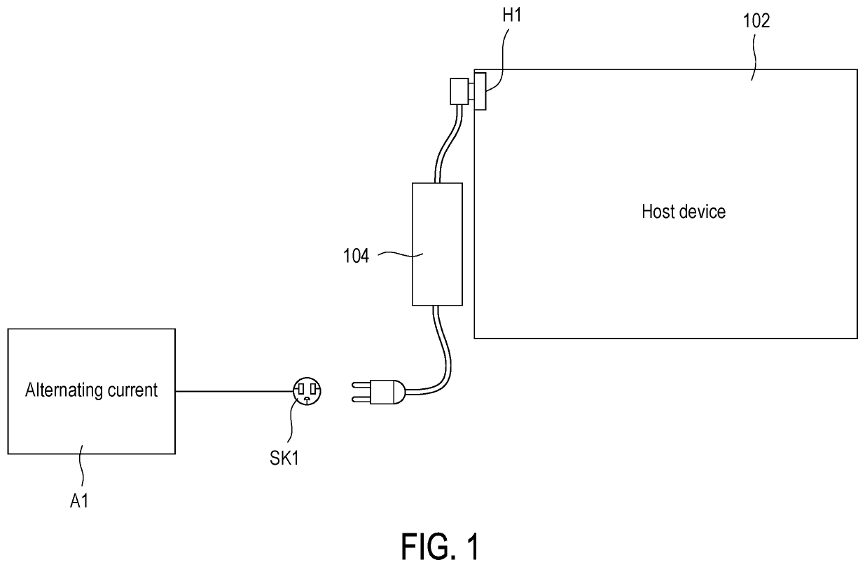

FIG. 1 is a schematic view of an electronic system using a USB type-C port according to an embodiment of the disclosure. Referring to FIG. 1, The electronic system may include a host device 102 and a power adapter 104. The host device 102 may be, for example, a notebook computer, but not limited thereto. The host device 102 includes a USB type-C port H1, and the USB type-C port H1 may support a dual-role port (DRP) function. The power adapter 104 is configured to connect an alternating current A1 to the USB type-C port H1. As shown in FIG. 1, the power adapter 104 is connected to the alternating current A1 via a socket SK1 to convert the alternating current A1 into a system voltage and supply power to the host device 102.

Furthermore, when using the USB type-C port H1 for power supply, a set of configuration channel (CC) pins (e.g., CC1 pin and CC2 pin) are required to communicate between the host device 102 and the power adapter 104 for a power delivery (PD) protocol to determine the power role of the two devices as the power source or power sink (to execute power source mode or power sink mode). For example, the host device 102 may perform power role identification and negotiation with the power adapter 104 through the CC pin and choose to execute the power source mode or the power sink mode. In response to the host device 102 executing the power sink mode through negotiation, the power adapter 104 executes the power source mode correspondingly to complete the pairing of the power roles.

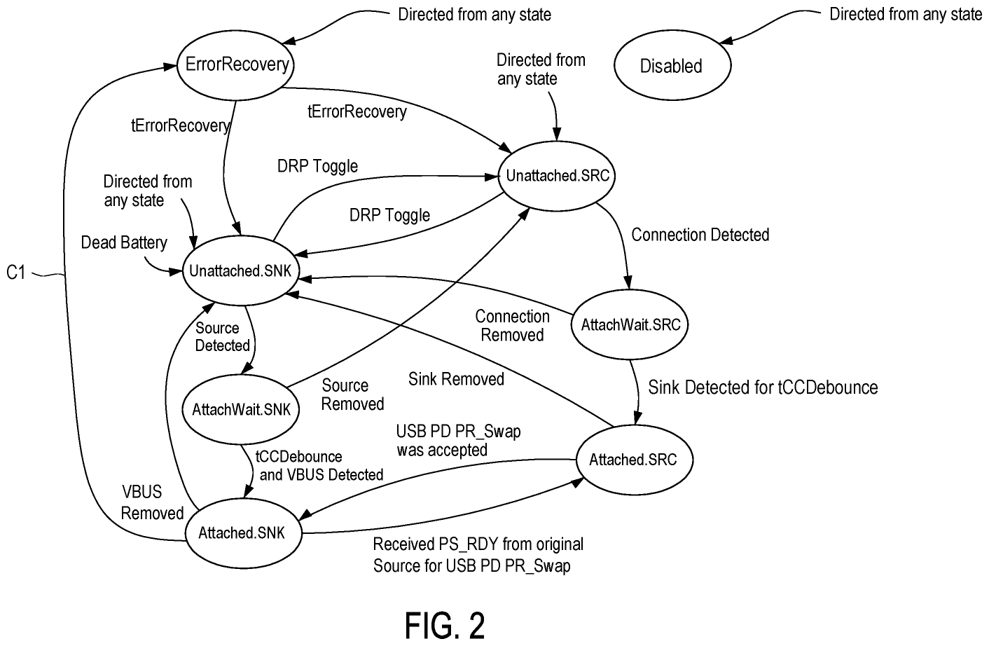

FIG. 2 is a schematic view of a PD state machine of a USB type-C port according to an embodiment of the disclosure. The PD state machine may be implemented by, for example, a processor or a digital logic circuit. In the embodiment of FIG. 2, except for a transition condition C1 in which an “Attached.SNK” state is transitioned to an “ErrorRecovery” state, the rest of the states of the state machine and the transition conditions are conventional USB type-C ports' machine states of the PD state machine and transition conditions. In the embodiment of FIG. 2, in the “Disabled” state, the power adapter 104 is removed from the USB type-C port H1. In response to the power adapter 104 connected to the USB type-C port H1, the power adapter 104 negotiates with the host device 102 until the power adapter 104 enters an “Unattached.SRC” state and the host device 102 enters an “Unattached.SNK” state. That is, the power adapter 104 is in a power source mode (power source) and the host device 102 is in a power sink mode (power sink). The host device 102 enters an “AttachWait.SNK” state after detecting a power source and enters the “Attached.SNK” state after elapsing a connection detection time (tCCDebounce) and detecting a voltage (VBUS) of the power transmission cable. On the other hand, the power adapter 104 enters an “AttachWait.SRC” state after detecting the power sink and enters an “Attached.SRC” state after elapsing the connection detection time (tCCDebounce).

In this embodiment, in the “AttachWait.SNK” state, when a response from the power adapter 104 is not yet received by the host device 102, the host device 102 may send a hard reset request to the power adapter 104. After sending a hard reset request, the host device 102 determines whether to enter an error recovery state (“ErrorRecovery” state) according to whether an initialization signal (INT #) thereof is at a first preset level for a first preset time (e.g., 3 seconds, but not limited thereto). The initialization signal is configured to indicate to the host device 102 whether to execute shutdown. For example, in response to the initialization signal being at the first preset level (e.g., low voltage level), the host device 102 is not allowed to shut down. In response to the initialization signal being at a second preset level (e.g., a high voltage level), the host device 102 is allowed to shut down. For example, after sending the hard reset request, the host device 102 may enter the error recovery state (“ErrorRecovery” state) in response to the initialization signal being at the first preset level for the first preset time (i.e., the transition condition C1 is satisfied), so that the initialization signal is changed to the second preset level. Hence, the host device 102 may be prevented from failing to shut down. The transition condition C1 may be set, for example, by modifying the firmware of the host device 102. In the “ErrorRecovery” state, after elapsing an error recovery time (tErrorRecovery), the host device 102 may enter the “Unattached.SNK” state.

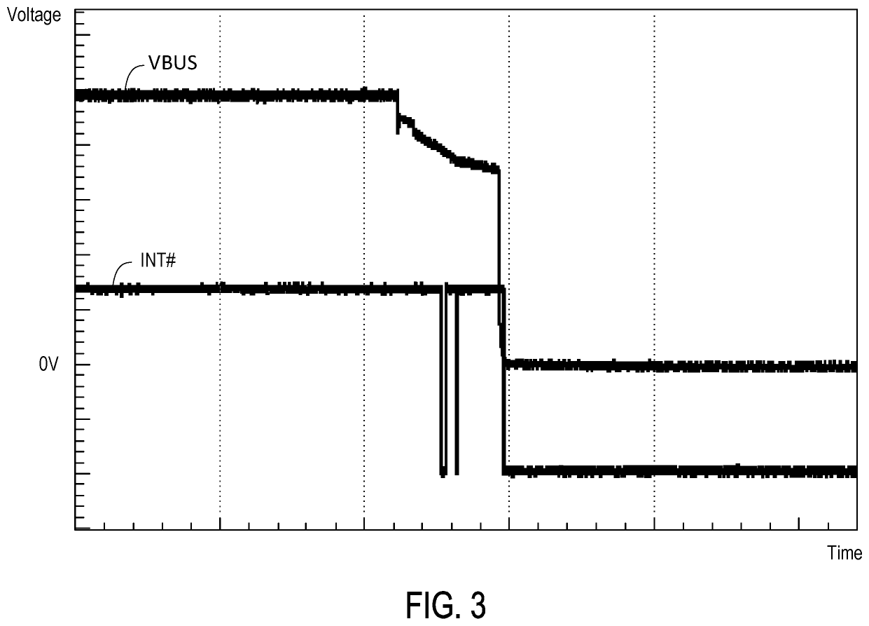

For example, in response to the power adapter 104 in the state of connecting the host device 102 and the alternating current A1 and the side connected to the alternating current A1 is removed from the alternating current A1 and becomes only connected to the host device 102, since there is still residual voltage on the power transmission cable of the USB type-C port H1 (i.e., the voltage (VBUS) of the power transmission cable of the USB type-C port H1 is not falling fast enough), the host device 102 may still detect a pull-up resistance (Rp) of the power adapter 104, which causes the host device 102 to stay in the “Attached.SNK” state instead of transitioning to the “Unattached.SNK” state. In a conventional PD state machine, since the host device 102 does not receive a response from the power adapter 104, the host device 102 sends a hard reset request to the power adapter 104 and detects the voltage (VBUS) of the power transmission cable. At this time, since the voltage (VBUS) of the power transmission cable of the USB type-C port H1 does not drop to a preset voltage (e.g., 0V), the host device 102 does not transition to the “Unattached.SNK” state. In response to the voltage (VBUS) of the power transmission cable eventually dropping to 0V and the host device 102 detecting that the configuration channel (CC) pin is in a disconnection state, the host device 102 stops communicating with the power adapter 104 and no longer detects the voltage (VBUS) of the power transmission cable. In this way, the host device 102 continues to stay in the “Attached.SNK” state, and then the initialization signal (INT #) continues to be at the first preset level (as shown in FIG. 3, the initialization signal INT #continues to be at the low voltage level). As a result, the host device 102 fails to shut down. In this embodiment, after sending the hard reset request, the host device 102 may enter the error recovery state (“ErrorRecovery” state) in response to the initialization signal being at the first preset level for the first preset time. At this time, the initialization signal is returned to the second preset level, thereby preventing the host device 102 from failing to shut down.

It is worth mentioning that in some embodiments, the host device 102 may also determine whether to force the initialization signal to change to the second preset level according to whether the initialization signal is at the first preset level for a second preset time. For example, the host device 102 may force the initialization signal to change to the second preset level in response to the initialization signal being at the first preset level for the second preset time (e.g., by connecting the initialization signal pin to a specific voltage through a hardware circuit to force the initialization signal to change to the second preset level, but not limited thereto). The second preset time may be, for example, greater than the first preset time of the above-mentioned embodiment. The second preset time may be, for example, 5 seconds, but not limited thereto. In other embodiments, the host device 102 may also determine whether to force the initialization signal to change to the second preset level according to whether a voltage of a power transmission cable of the power adapter 104 is lower than a preset voltage (e.g., 0V, but not limited thereto). For example, the host device 102 forces the initialization signal to change to the second preset level in response to the initialization signal being at the first preset level for the second preset time and the voltage of the power transmission cable being lower than the preset voltage. In this way, the initialization signal may still be prevented from staying at the first preset level, preventing the host device 102 from shutting down.

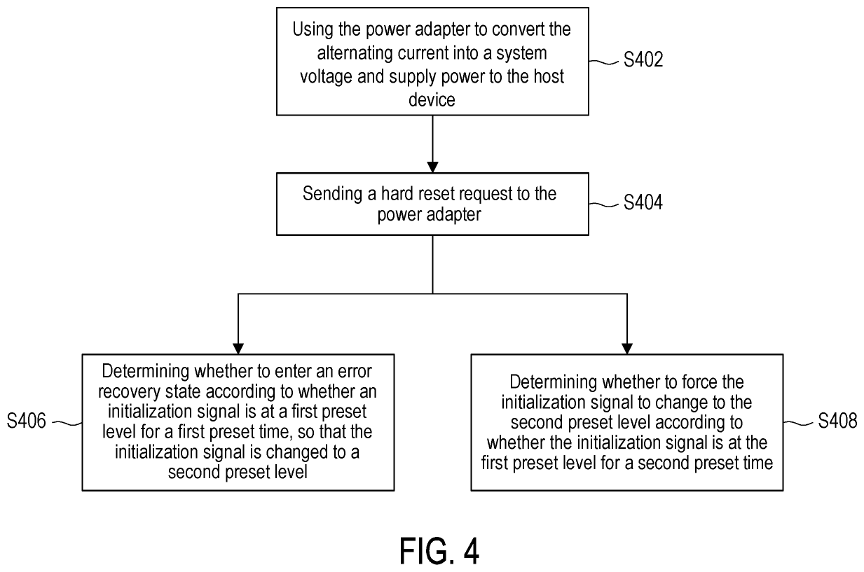

FIG. 4 is a flow chart of an abnormal elimination method of an electronic system using a USB type-C port according to an embodiment of the disclosure. The electronic system includes a host device with a USB type-C port and a power adapter configured to connect an alternating current to the USB type-C port. As known from the above embodiments, the abnormal elimination method of the electronic system using the USB type-C port may include at least the following steps. First, the power adapter is used to convert the alternating current into a system voltage, and power is supplied to the host device (step S402). Next, when a response from the power adapter is not yet received, the host device is controlled to send a hard reset request to the power adapter 104 (step S404). Then, whether to enter an error recovery state (“ErrorRecovery” state) is determined according to whether an initialization signal is at a first preset level for a first preset time, so that the initialization signal is changed to a second preset level (step S406). The initialization signal indicates to the host device whether to execute shutdown. In this embodiment, in response to the initialization signal being at the first preset level, the host device is not allowed to execute shutdown. In response to the initialization signal being at the second preset level, the host device is allowed to execute shutdown. For example, in response to the initialization signal being at the first preset level for the first preset time, the host device is controlled to enter the error recovery state. Therefore, the initialization signal is then changed to the second preset level, thereby preventing the host device from failing to shut down. Alternatively, after step S404, whether to force the initialization signal to change to the second preset level is determined according to whether the initialization signal is at the first preset level for a second preset time (step S406) to prevent the host device from failing to shut down. The second preset time may be set, for example, longer than the first preset time. In other embodiments, whether to force the initialization signal to change to the second preset level may also be determined according to whether a voltage of a power transmission cable of the power adapter is lower than a preset voltage (e.g., 0V, but not limited thereto). For example, the initialization signal is forced to change to the second preset level in response to the initialization signal being at the first preset level for the second preset time and the voltage of the power transmission cable being lower than the preset voltage. In this way, the initialization signal may still be prevented from staying at the first preset level, so as to prevent the host device from failing to shut down.

To sum up, after sending a hard reset request to a power adapter, the host device of an embodiment of the disclosure determines whether to enter an error recovery state according to whether an initialization signal is at a first preset level for a first preset time, so that the initialization signal is changed to a second preset level, or whether to force the initialization signal to change to the second preset level according to whether the initialization signal is at the first preset level for a second preset time. In this way, the initialization signal may be prevented from staying at the first preset level, so that the host device may return to a normal shutdown state, which may effectively prevent the system from malfunctioning due to the PD protocol of the USB type-C port.

What is claimed is:

1. An electronic system using a USB type-C port, comprising:
a host device, comprising a USB type-C port; and
a power adapter, configured to connect an alternating current to the USB type-C port and convert the alternating current into a system voltage and supply power to the host device, wherein after sending a hard reset request to the power adapter, the host device determines whether to enter an error recovery state according to whether an initialization signal is at a first preset level for a first preset time, so that the initialization signal is changed to a second preset level, or whether to force the initialization signal to change to the second preset level according to whether the initialization signal is at the first preset level for a second preset time, wherein the initialization signal indicates to the host device whether to execute shutdown.

2. The electronic system using the USB type-C port according to claim 1, wherein the host device also determines whether to force the initialization signal to change to the second preset level according to whether a voltage of a power transmission cable of the power adapter is lower than a preset voltage.

3. The electronic system using the USB type-C port according to claim 2, wherein the host device forces the initialization signal to change to the second preset level in response to the initialization signal being at the first preset level for the second preset time and the voltage of the power transmission cable being lower than the preset voltage.

4. The electronic system using the USB type-C port according to claim 2, wherein the preset voltage is 0V.

5. The electronic system using the USB type-C port according to claim 1, wherein the host device enters the error recovery state in response to the initialization signal being at the first preset level for the first preset time.

6. The electronic system using the USB type-C port according to claim 1, wherein the second preset time is longer than the first preset time.

7. The electronic system using the USB type-C port according to claim 1, wherein the host device executes shutdown in response to the initialization signal being at the second preset level.

8. The electronic system using the USB type-C port according to claim 1, wherein the USB type-C port supports a dual-role port (DRP) function.

9. The electronic system using the USB type-C port according to claim 1, wherein the power adapter connects to the alternating current via a socket.

10. The electronic system using the USB type-C port according to claim 1, wherein the second preset level is higher than the first preset level.

11. An abnormal elimination method of an electronic system, wherein the electronic system comprises a host device with a USB type-C port and a power adapter configured to connect an alternating current to the USB type-C port, and the abnormal elimination method of the electronic system using the USB type-C port comprises:
using the power adapter to convert the alternating current into a system voltage and supply power to the host device; and
determining whether to enter an error recovery state according to whether an initialization signal is at a first preset level for a first preset time after sending a hard reset request to the power adapter by the host device, so that the initialization signal is changed to a second preset level, or whether to force the initialization signal to change to the second preset level according to whether the initialization signal is at the first preset level for a second preset time, wherein the initialization signal indicates to the host device whether to execute shutdown.

12. The abnormal elimination method of the electronic system according to claim 11, comprising:
determining whether to force the initialization signal to change to the second preset level according to whether a voltage of a power transmission cable of the power adapter is lower than a preset voltage.

13. The abnormal elimination method of the electronic system according to claim 12, wherein in response to the initialization signal being at the first preset level for the second preset time and the voltage of the power transmission cable being lower than the preset voltage, the initialization signal is forced to change to the second preset level.

14. The abnormal elimination method of the electronic system according to claim 12, wherein the preset voltage is 0V.

15. The abnormal elimination method of the electronic system according to claim 11, wherein in response to the initialization signal being at the first preset level for the first preset time, the host device is controlled to enter the error recovery state.

16. The abnormal elimination method of the electronic system according to claim 11, wherein the second preset time is longer than the first preset time.

17. The abnormal elimination method of the electronic system according to claim 11, wherein the host device executes shutdown in response to the initialization signal being at the second preset level.

18. The abnormal elimination method of the electronic system according to claim 11, wherein the USB type-C port supports a dual-role port (DRP) function.

19. The abnormal elimination method of the electronic system according to claim 11, wherein the power adapter connects to the alternating current via a socket.

20. The abnormal elimination method of the electronic system according to claim 11, wherein the second preset level is higher than the first preset level.
